(19) United States
(12) Patent Application Publication
(10) Pub. No.: US 2014/0040036 A1
(43) Pub. Date: Feb. 6, 2014

(54) ADVERTISEMENT PLATFORM

(71) Applicants: Hong Xiao, Acton, MA (US); Dongchen Wang, Concord, MA (US); Andre Turner, Belmont, MA (US); Azim Nasir, Foxboro, MA (US)

(72) Inventors: Hong Xiao, Acton, MA (US); Dongchen Wang, Concord, MA (US); Andre Turner, Belmont, MA (US); Azim Nasir, Foxboro, MA (US)

(73) Assignee: VERIZON PATENT AND LICENSING INC., Basking Ridge, NJ (US)

(21) Appl. No.: 13/565,076

(22) Filed: Aug. 2, 2012

(51) Int. Cl. G06Q 30/02

(52) U.S. Cl. 705/14.64

(57) ABSTRACT

Method, device, and storage medium for providing an advertisement platform that allows users to purchase advertisement space on user devices. The advertisement platform delivers the advertisements to the user devices. The advertisement platform uses information from the users of the user devices to identify the available advertisement space. The advertisement platform calculates credits to be applied to services associated with the users of the user devices based on the available advertisement space offered by the users of the user devices.

### BACKGROUND

As the proliferation of user devices increases, service providers and other businesses are looking for ways to reach users with advertising. Users are also interested in receiving advertisements, particularly when the advertisements offer discounts or other types of benefits.

### DESCRIPTION OF THE DRAWINGS

FIG. 1A is a diagram illustrating an exemplary environment in which an exemplary embodiment of an advertisement platform may be implemented;

FIG. 1B is a diagram illustrating exemplary elements for the devices illustrated in FIG. 1A;

FIGS. 2A and 2B are diagrams illustrating the advertisement platform in accordance with exemplary scenarios;

FIG. 3 is a diagram illustrating the advertisement platform in accordance with other exemplary scenarios;

FIG. 4 is a diagram illustrating exemplary components of a device that may correspond to one or more of the devices previously depicted; and

FIG. 5 is a flow diagram illustrating an exemplary process pertaining to an exemplary embodiment of the advertisement platform.

### DETAILED DESCRIPTION OF PREFERRED EMBODIMENTS

The following detailed description refers to the accompanying drawings. The same reference numbers in different drawings may identify the same or similar elements.

The term “advertisement space,” as used herein, includes a resource used by a user device to allow a user to consume an advertisement. For example, an advertisement may include a video clip, a still image, or other visual content. According to such an example, the advertisement space includes a display area of a display associated with the user device. Additionally, for example, an advertisement may use other resources of the user device, such as a speaker (e.g., for audio content), or other mechanisms (e.g., a vibration mechanism, a haptic mechanism, etc.).

According to an exemplary embodiment, an advertisement platform allows users (e.g., advertisers or other entities) to purchase advertisement space. For example, a user may purchase display space of a user device and use that display space for advertising purposes. According to an exemplary embodiment, the advertisement platform auctions advertisement space to the advertisers or other entities. According to another exemplary embodiment, the advertisement platform sets a price for advertisement space. For example, the price may be set by a data service provider associated with advertisements or set by a service provider of the advertisement platform.

According to an exemplary embodiment, the advertisement platform provides information to allow users to make informed decisions for purchasing advertisement space. For example, the advertisement platform provides information pertaining to the usage behavior of users of the user devices (e.g., data search activities, multimedia consumption, web browsing, etc.), user device characteristics (e.g., type of user device, display resolution, etc.), network characteristics used by the users via the user devices (e.g., 4G network, 3G network, etc.), and user demographics (e.g., age, gender, income, etc.).

According to an exemplary embodiment, the advertisement platform provides information pertaining to user responses (e.g., users of mobile devices) to advertisements and statistical information pertaining to the number of mobile devices turned on or connected to a service (e.g., a mobile service, etc.) during a particular period, within a geographic area, etc.

According to an exemplary embodiment, a user device includes an advertisement agent that manages the provisioning of advertisements to a user. According to an exemplary embodiment, the advertisement agent performs real-time tracking of user behavior. According to an exemplary embodiment, the advertisement agent allows the user to configure user settings pertaining to advertisements. For example, the user may configure how much advertisement space is available to the advertisement platform. Additionally, for example, the user may turn on and turn off the availability of the advertisement space. By way of example, the user may turn off the availability of the advertisement space based on the user's location or some other type of user-configurable criterion. The advertisement agent allows the user to configure other settings (e.g., language settings, etc.).

According to an exemplary embodiment, the advertisement agent provides on-demand advertisements. For example, the user may request an advertisement (e.g., by category of product or service, by name of product or service, etc.) on-demand.

According to an exemplary embodiment, the advertisement agent provides game-like features for unlocking the user device using advertisements. For example, the user may have to interact with an advertisement, close the advertisement, or perform some gesture on the display of the user device to unlock the user device.

According to an exemplary embodiment, advertisement space is divided into sub-divisions of a display of the user device. For example, according to an exemplary implementation, the display of the user device is divided into equal sections or cells. According to an exemplary implementation, depending on the location of the cell, the time of day, the day of week, or combination thereof, the price for purchasing the cell varies. Additionally, for example, advertisement space may be shared by different advertisers based on the location of the user device receiving the advertisement, the time of day, the day of week, etc. These parameters, as well as other parameters described herein may be a parameter pertaining to the purchase of advertisement space. For example, a cell or multiple cells may be available for purchase during a particular time window, certain location, etc.

According to an exemplary embodiment, the advertisement space is available on a home screen, a main screen, or the like. According to another exemplary embodiment, the advertisement space extends to multiple screens of the user device. For example, in addition to providing advertisement space on a main screen, advertisement space is available when applications are executed (e.g., playing a movie, etc.) and empty space is available.

According to an exemplary embodiment, users of the user devices receive discounts or other types of benefits based on the amount of advertisement space configured as available, the amount of time the advertisement space is available, or a combination thereof. For example, a service provider that hosts the advertisement platform may provide other services, such as a mobile service, an Internet service, etc., to users of the user devices. According to such an example, the service provider may reduce a monthly bill, offer free minutes, etc., to a user based on the advertisement space configured.

While exemplary embodiments provided in this description may be implemented based on the use of a particular network architecture, platform, device, etc., such implementations are not intended to be restrictive or provide an exhaustive treatment, as such. In other words, the embodiments described herein may be implemented using other suitable network architectures, platforms, devices, etc., which may not be specifically described.

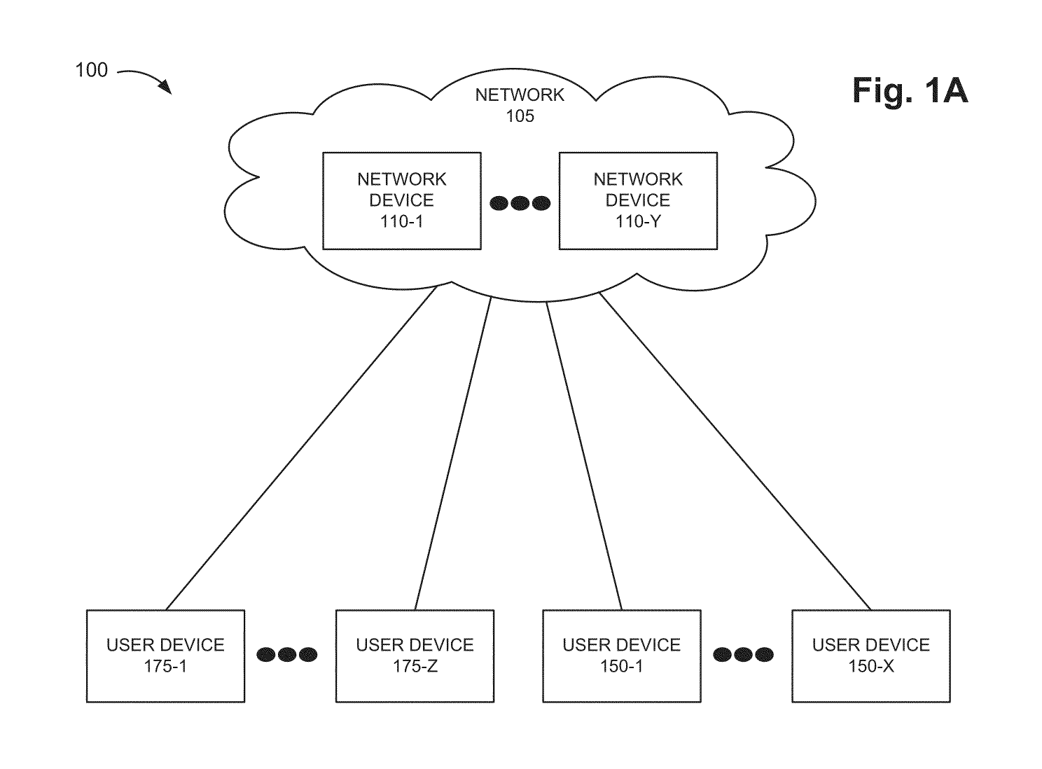

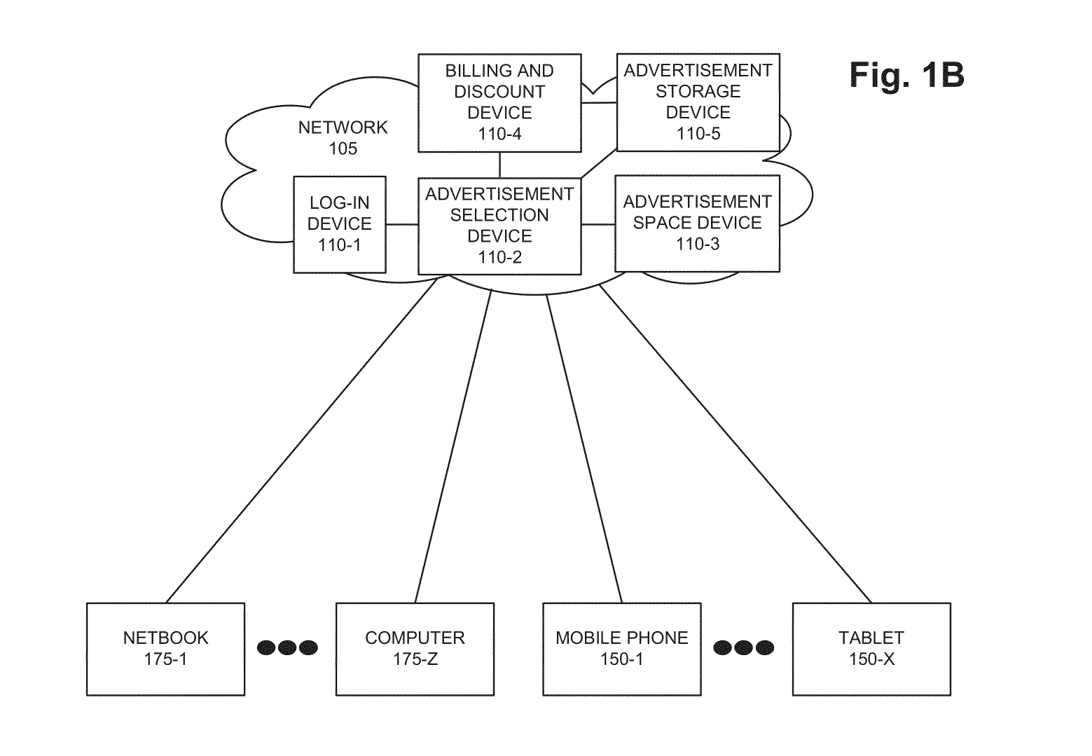

FIG. 1A is a diagram illustrating an exemplary environment in which an exemplary embodiment of the advertisement platform may be implemented. As illustrated, an environment 100 includes a network 105. Network 105 includes network devices 110-1 through 110-Y, in which Y>1 (also referred to collectively as network devices 110 and individually as network device 110). Environment 100 also includes user devices 150-1 through 150-X, in which X>1 (also referred to collectively as user devices 150 and individually as user device 150) and user devices 175-1 through 175-Z, in which Z>1 (also referred to collectively as user devices 175 and individually as user device 175).

The number of devices and networks, and the configuration in environment 100 are exemplary. According to other embodiments, environment 100 may include additional devices, fewer devices, different devices, and/or differently arranged devices, than those illustrated in FIG. 1A. Additionally, or alternatively, environment 100 may include an additional network and/or a differently arranged network, than illustrated in FIG. 1A.

According to other embodiments, a single device in FIG. 1A may be implemented as multiple devices. Alternatively, for example, multiple devices in FIG. 1A may be implemented as a single device. For example, multiple devices of network devices 110 may be implemented as a single device. A device may be implemented according to one or multiple network architectures (e.g., a client device, a server device, a peer device, a proxy device, or a combination thereof).

Also, according to other embodiments, one or more functions and/or processes described as being performed by a particular device may be performed by a different device, or some combination of devices, which may or may not include the particular device.

Environment 100 may be implemented to include wired and/or wireless connections among the devices and the network illustrated. A connection may be direct or indirect and may involve intermediary device(s) and/or network(s) not illustrated in FIG. 1A. Additionally, the number and the arrangement of connections between the devices and the network are exemplary.

Network 105 includes a network that provides the functionality of the advertisement platform, as described herein. According to an exemplary embodiment, network 105 is implemented as a cloud service or a web service. Network 105 may include or connect to other network(s) that provide other services, such as a mobile service or an Internet service. For example, network 105 may include or connect to a mobile network, the Internet, or other network that provides access to or provides a mobile service, an Internet service, etc.

Network devices 110 include network devices that provide, for example, user interfaces, authentication and/or authorization, and access to and use of the advertisement platform, via user devices 175. The advertisement platform allows users (e.g., advertisers or other entities) to purchase advertisement space associated with user devices 150, as described herein. One or multiple network devices 110 may be implemented as an application server device, a web device, a gateway device, or other suitable network devices. Network devices 110 include network devices that provide access to and use of the advertisement platform via user devices 150.

User device 150 includes a device having communicative capabilities. For example, user device 150 may be implemented as a smartphone, a tablet device, a netbook, a palmtop device, or the like. User device 150 may be implemented as another type of device, such as, for example, a vehicular communication system, etc. User device 150 includes an advertisement agent, as described herein.

User device 175 includes a device having communicative capabilities. For example, user device 175 may be implemented as a computer (e.g., a desktop computer, a laptop computer, etc.), a tablet device, etc. User device 175 has the capability to communicate with network 105 and one or more of network devices 110. For example, user device 175 may include a browser or other software that allows the user to communicate with the advertisement platform.

FIG. 1B is a diagram illustrating exemplary elements (e.g., logic) for the devices illustrated in FIG. 1A. As illustrated, network 105 includes a log-in device 110-1, an advertisement selection device 110-2, an advertisement space device 110-3, a billing and discount device 110-4, and an advertisement storage device 110-5. User devices 150 include various mobile devices, such as a mobile phone 150-1 and a tablet 150-2 (referred to as mobile devices 150). User devices 175 include various devices, such as a netbook 175-1 and a computer 175-Z.

According to an exemplary embodiment, log-in device 110-1 provides access to the advertisement platform provided by network 105. For example, log-in device 110-1 provides interfaces (e.g., user interfaces, network interfaces, etc.) to allow an advertiser to sign-on to the advertisement platform. Log-in device 110-1 may be implemented as, for example, a portal to the advertisement platform. Log-in device 110-1 may store subscription information to validate access. For example, advertisers may gain access to the advertisement platform, via log-in device 110-1, by entering user identifiers and passwords. The advertisement service provided by the advertisement platform may be implemented as a fee-based subscription or a free subscription.

According to an exemplary embodiment, advertisement selection device 110-2 provides user interfaces to allow users to purchase advertisement space. The user interfaces provide information pertaining to the usage behavior of users of mobile devices 150. The usage behavior may include data search activity (e.g., via a search engine, etc.), multimedia consumption (e.g., movies watched, YouTube® clips watched, etc.), web browsing, downloads, uploads, etc. The usage behavior also includes user behavior pertaining to advertisements. The user interfaces also provide information pertaining to the device characteristics of mobile devices 150. For example, the information includes the type of user device (e.g., tablet device, smartphone, make, model, etc.), operating system, display size, display resolution, etc. The user interfaces also provide information pertaining to the network characteristics that users (e.g., users of mobile devices 150) use to access and use a network. For example, the information includes the type of network (e.g., a 4G network, a 3G network, a private network, a public network, etc.). The information may also include subscription information. For example, if the service provider of the advertisement platform also is the mobile service provider for the users of mobile devices 150, the information may include data plan information. The user interfaces also provide information pertaining to demographics of the users of mobile devices 150. For example, the demographic information includes age, gender, address information, annual income, etc.

According to an exemplary embodiment, the advertisement platform provides information pertaining to user responses (e.g., the number and the type of clicks or interactivity with advertisements) to advertisements, such as purchases made, closing advertisements, navigating through advertisements, etc. For example, the advertisement agent of mobile device 150 provides the advertisement platform with usage behavior information, which includes user interaction with advertisements.

According to an exemplary embodiment, the advertisement platform provides statistical information pertaining to the number (e.g., average number or range) of mobile devices 150 turned on or connected to a service (e.g., a mobile service, etc.) during a particular time period, within a geographic area, etc. In this way, when users (e.g., advertisers) of the advertisement platform purchase advertisement space, the advertisers have some knowledge as to the number of users (e.g., users of mobile devices 150) the advertisements will reach. Additionally, the advertisement platform may calculate prices to be set for advertisement space based on the number of mobile devices 150 turned on or connected during a particular time period, etc. According to an exemplary embodiment, the advertisement platform may track the number of views by users that an advertisement receives. For example, the number of views may be a criterion that the service provider of the advertisement platform uses for deciding when the advertisement should no longer be provided (e.g., displayed) to users (e.g., users of mobile devices 150). By way of further example, advertisers may purchase advertisement space based on the number of views by users of mobile devices 150 and/or some other criterion (e.g., number of interactive responses, such as clicks, etc.).

According to an exemplary embodiment, advertisement selection device 110-2 provides user interfaces that indicate the price of advertisement space. According to an exemplary implementation, prices for advertisement space may vary based on date and time, day of week, whether a holiday, night time versus daytime, location of and/or number of cells (e.g., display area), the number of screens (e.g., home screen, multiple screens, etc.), etc. By way of further example, the price of advertisement space may be higher for a holiday, during daytime hours, placement or location of an advertisement on the display of mobile device 150, etc. Alternatively, according to an exemplary embodiment, advertisement selection device 110-2 provides user interfaces that allows users to bid for advertisement space (e.g., such as an auction).

According to an exemplary embodiment, advertisement space device 110-3 stores advertisement space information pertaining to advertisement space on mobile devices 150. For example, the advertisement space information may include the maximum advertisement space for each mobile device 150, the amount of advertisement space currently being used, and the amount of available advertisement space for purchase.

According to an exemplary embodiment, advertisement space device 110-3 performs real-time tracking of available and/or used advertisement space for each mobile device 150. For example, the available advertisement space of mobile device 150 may change over time. Advertisement space device 110-3 continuously updates the advertisement space information so that users (e.g., advertisers) may purchase advertisement space that is available.

According to an exemplary embodiment, advertisement space device 110-3 receives user requests (e.g., from a user of mobile device 150) and/or stores user settings pertaining to advertisement space of mobile device 150. By way of example, a user setting may indicate that a limited amount of advertisement space is available. For example, the user setting may indicate to limit the available advertisement space to a percentage (e.g., 50%) of total advertisement space. Additionally, or alternatively, the user setting may indicate to limit the available advertisement space based on other criterion, such as time (e.g., day, hour, etc.), type of advertisement (e.g., no videos, only images, etc.), location of mobile device 150, battery charge of mobile device 150 (e.g., under 50% battery charge no advertisements, etc.), type of product or service being advertised, during certain activities (e.g., while driving, etc.), when certain applications are running on mobile device 150, etc. For some criteria described, such as battery charge of mobile device 150 or when certain applications are running, mobile device 150 may transmit a message to advertisement space device 110-3 to indicate a state of mobile device 150. In response, advertisement space device 110-3 updates the advertisement space information.

According to another example, a user may configure mobile device 150 to not accept advertisements on a more impromptu or temporary basis. According to such an example, mobile device 150 transmits a user request to advertisement space device 110-3. The user request includes configuration information pertaining to available advertisement space. For example, assume the user rarely watches a movie on mobile device 110-3. However, on this day, the user decides to watch a movie. The user may request, via a user interface, that no advertisement space is available during the time the user watches the movie on mobile device 150.

According to an exemplary embodiment, billing and discount device 110-4 manages billing pertaining to the purchase of advertisement space, and manages the discounts earned by users of mobile devices 150. For example, billing and discount device 110-4 accounts for the purchases made by advertisers or other entities of advertisement space. Additionally, for example, billing and discount device 110-4 calculates and issues discounts to users of mobile devices 150 based on configurable incentives created by the service provider of the advertisement platform. For example, discounts may be provided to users of mobile devices 150 based on the amount of advertisement space the users allow. By way of further example, the amount of advertisement space may be measured in terms of time and display area. Billing and discount device 110-4 may calculate the amount of advertisement space, on a per mobile device 150 basis, based on the advertisement space information stored by advertisement space device 110-3. Billing and discount device 110-4 calculates a discount based on the calculated amount of advertisement space.

According to an exemplary implementation, the discount may apply to services used by users of mobile device 150. For example, the discount may apply to a mobile service, a home monitoring service, an Internet service, or other mobile device-based service (e.g., a television service, etc.). Billing and discount device 110-4 identifies a service used by the user of mobile device 150 and selects a discount. As an example, the service provider of the advertisement platform may provide one or more of the above-mentioned services to the users of mobile devices 150. Alternatively, the users may specify services that they wish to receive discounts. For example, a discount pertaining to a mobile service may include free peak minutes, a reduced monthly fee for mobile service, no roaming charges, etc. Additionally, for example, a discount pertaining to Internet service may include increased download and/or upload speeds, a reduced monthly fee for a data plan, free access to certain multimedia (e.g., movies, etc.), etc. Also, for example, a discount pertaining to home monitoring service may include reduced rates in equipment charges (e.g., video cameras or other security devices), a reduced monthly fee for the home monitoring service, etc. Also, for example, a discount may be applied to a television service. For example, the discount may include a reduced monthly fee for the television service, a free trial period of a premium channel (e.g., HBO, etc.), free pay-per-views, etc. According to an exemplary implementation, billing and discount device 110-4 uses discount information to select a suitable discount in view of the calculated amount of advertisement space.

According to an exemplary embodiment, advertisement storage device 110-5 stores advertisements. For example, advertisers or other entities may store advertisements to be used by the advertisement platform. The advertisement platform uses the advertisements to satisfy advertisement space. Advertisements may be implemented in various forms, such as audio/videos, still images, overlays, interactive, icons, etc. Advertisements may be in different formats to accommodate the device capabilities of mobile devices 150. Advertisements may be in different languages. Advertisements may include various discounts (e.g., coupons or other types of discounts) pertaining to products, services, etc.

According to an exemplary embodiment, advertisement storage device 110-5 provides advertisements to mobile devices 150 on-demand. For example, users (e.g., users of mobile devices 150) can request advertisements on-demand from the advertisement platform via mobile device 150 (e.g., the advertisement agent) and advertisement storage device 110-5. According to other embodiments, advertisements may be stored by another party and push or pull communications between the party and the advertisement platform is performed to deliver the advertisements to mobile devices 150.

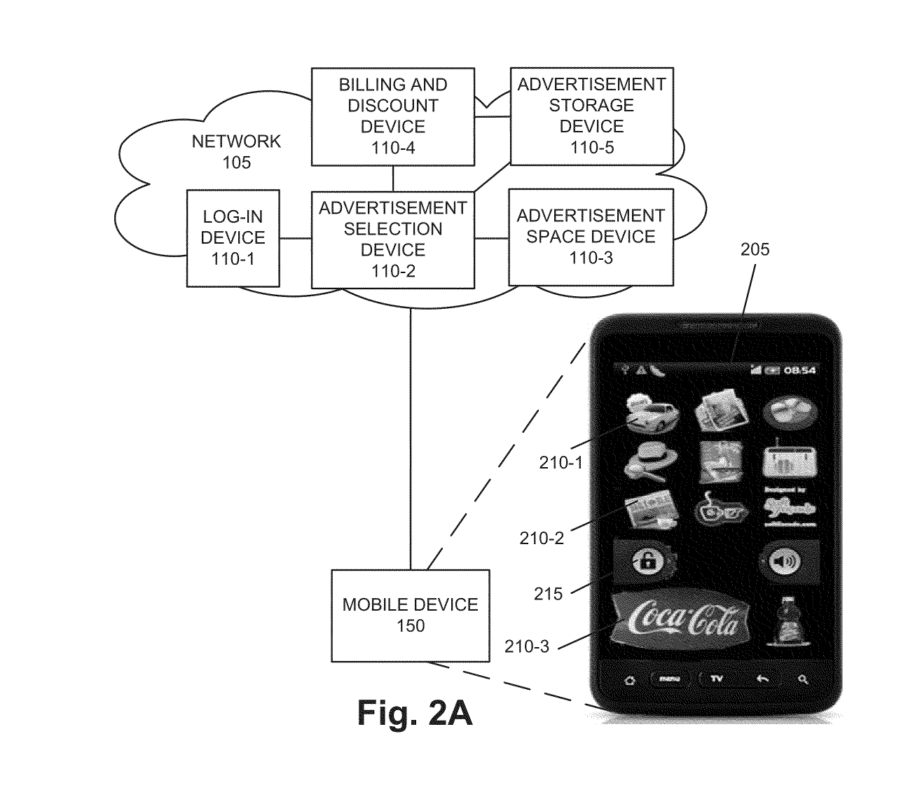

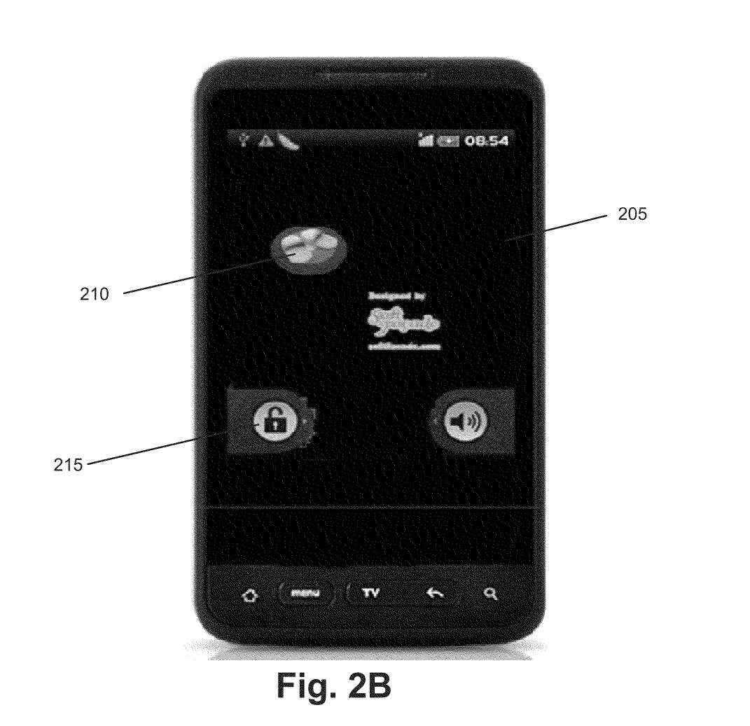

FIG. 2A is a diagram illustrating the advertisement platform in which an exemplary scenario is described. Assume that the user configured the advertisement agent on mobile device 150 to allow advertisement space to be used on mobile device 150. For example, the user configured the display area of a main screen 205 to be used for advertisements for the entire month. As illustrated, main screen 205 includes icons 210 (e.g., icons 210-1 through 210-3) that represent advertisements. Icons 210 may fade in and fade out dynamically, individually, or by group. According to an exemplary implementation, when the user touches an unlock icon 215, icons 210 fade out permanently. According to other implementations, the advertisements may be presented to the user in other formats, such as videos, etc. In contrast to icon 210, according to other implementations, an advertisement may occupy one or multiple cells or display areas of the display of mobile device 150.

According to an exemplary implementation, at the end of the month, the user receives a discount on his/her mobile phone service bill. The user also receives advertisements that provide some discounts, which allows the user to makes some purchases and save money. According to an exemplary implementation, if the user turns off the access to advertisement space on mobile device 150, billing and discount device 110-4 calculates a prorated credit for the user.

According to an exemplary implementation, advertisements may be context based. For example, the user may be presented with advertisements pertaining to food during lunch time, advertisements pertaining to new movies when the user is watching a movie on mobile device 150, or advertisements pertaining to a convenience store when mobile device 150 detects that the user is driving (e.g., near a convenience store). For example, mobile device 150 includes an accelerometer to detect the movement of the user and determine that the user is driving in a vehicle. The accelerometer information is provided to the advertisement agent of mobile device 150. The advertisement agent determines that the user is driving based on the accelerometer information. The advertisement agent may determine the location of the user, use a location service, or other well-known method to obtain the location of the user of mobile device 150.

According to an exemplary implementation, the user may be presented with targeted advertisements based on demographics of the user, usage behavior, etc., as previously described. According to an exemplary implementation, when the user touches icon 210, the user is provided with an advertisement details pertaining to the product, service, etc. Additionally, upon interaction with icon 210, mobile device 150 may invoke other software or services (e.g., map, a GPS service/system, etc.) pertaining to the product, service, etc.

According to other implementations, advertisements may be interactive. For example, when the user touches icon 210, icon 210 enlarges. According to another implementation, when the user double touches icon 210, the user is navigated to an advertisement detail page that provides information pertaining to icon 210. According to an exemplary implementation, an advertisement may occupy the entire screen or background area of a display of mobile device 150. The user may interact with the advertisement or touch a particular display area to close the advertisement.

Referring to FIG. 2A and according to another exemplary scenario, assume that the user wishes to invoke advertisement on-demand. For example, assume the user's television just broke and the user decides to purchase another television. The user invokes advertisement on-demand via a user interface provided by the advertisement agent of mobile device 150. The user may enter the product (e.g., a television), product information (e.g., plasma, LCD, etc.), a manufacturer (e.g., Panasonic, etc.), a store (e.g., Best Buy, etc.) to receive relevant advertisements. The advertisement agent communicates with the advertisement platform. The advertisement platform searches the advertisements stored by advertisement storage device 110-5 and provides advertisements that are applicable to the user's request. Alternatively, the advertisement agent may search and retrieve relevant advertisements based on the user's criteria.

According to an exemplary implementation, when no advertisements are available, the user may save this information (e.g., as a user setting) with the advertisement platform. The advertisement platform may push a relevant advertisement to mobile device 150 when one becomes available (e.g., stored in advertisement storage device 110-5).

According to an exemplary implementation, advertisement space device 110-3 stores advertisements in different languages. Users of mobile devices 150 may store a user setting pertaining to the language of advertisements that are used to satisfy available advertisement space.

Referring to FIG. 2B, according to an exemplary implementation, the advertisements may be used to provide game-like features pertaining to unlocking mobile device 150. For example, icons 210 may fade in and fade out and require the user to touch one or multiple icons 210 in order to unlock mobile device 150. According to another implementation, the user may perform a gesture on the display to unlock mobile device 150 while the advertisement is displayed. In this way, users may be exposed to advertisements in an interesting and non-intrusive manner. According to other implementations, icon 210 may move across main screen 205 or perform some other interactive prompting to engage the user before unlocking mobile device 150.

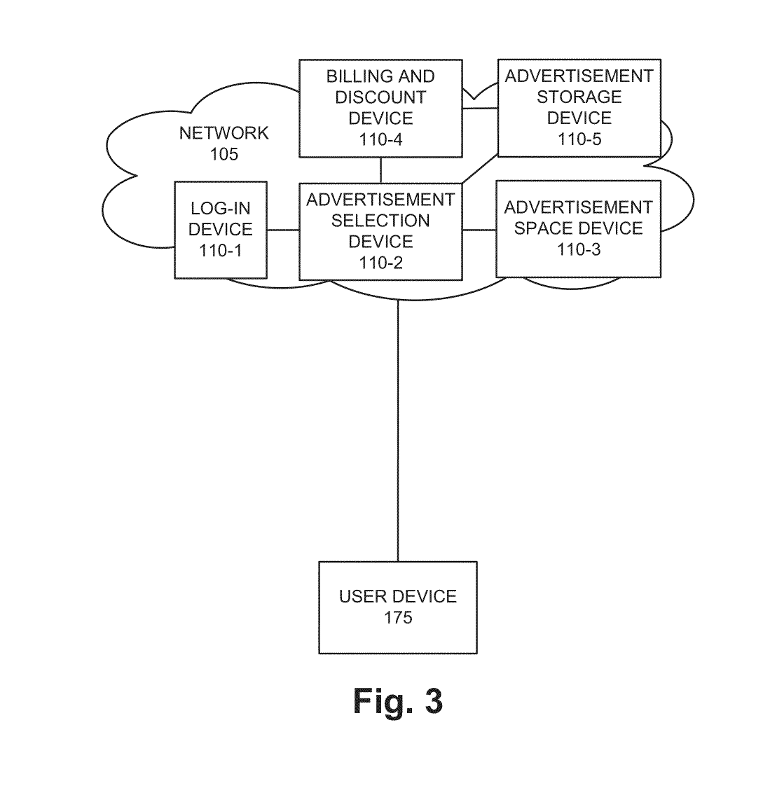

FIG. 3 is a diagram illustrating the advertisement platform in which an exemplary scenario is described. Referring to FIG. 3, assume that a user accesses the advertisement platform to purchase advertisement space. For example, assume that the user is a marketing manager working for a well-known fast-food chain. The user logs into the advertisement platform via user device 175 and log-in device 110-1. The user then peruses the information available (e.g., usage behavior, statistics, etc.) via advertisement selection device 110-2. The user purchases advertisement space on mobile devices 150 located in Chelmsford Mass. from 11:00 a.m. to 1:00 p.m. for a period of three weeks beginning from Jul. 1, 2012. Advertisement selection device 110-2 provides a user interface that indicates confirmation of the purchase. Billing and discount device 110-4 generates an invoice pertaining to the purchase, which is also displayed to the user. Thereafter, beginning on Jul. 1, 2012, users of mobile devices 150 receive promotional advertisements pertaining to the fast food chain when the users are located in Chelmsford during the above-mentioned time frame.

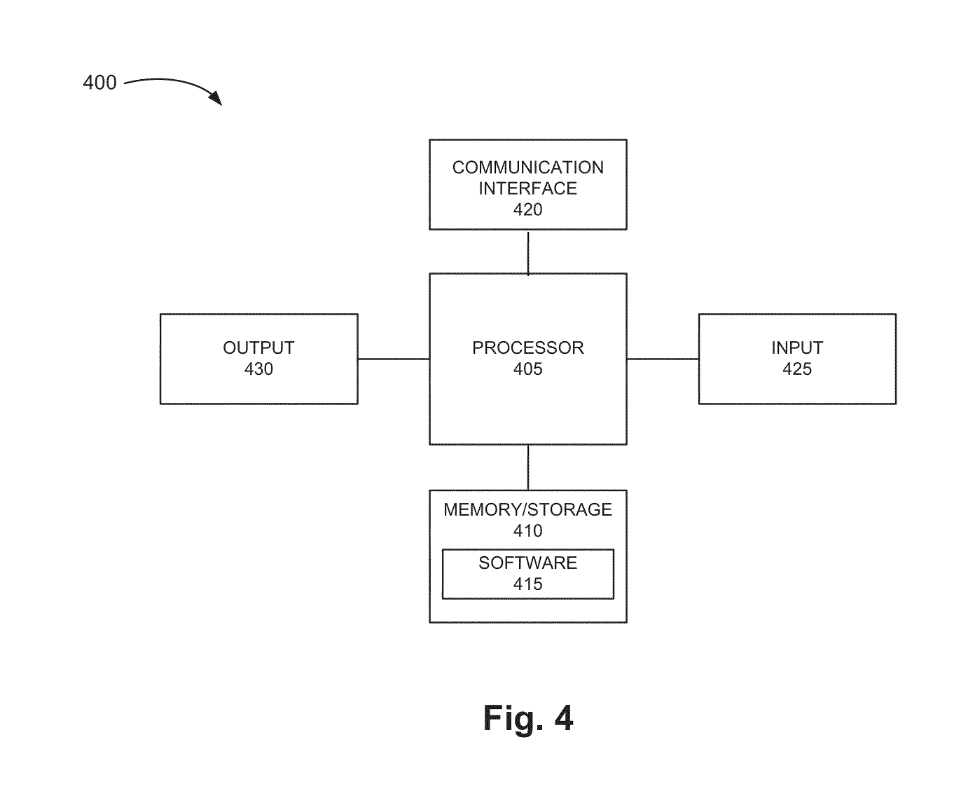

FIG. 4 is a diagram illustrating exemplary components of a device 400 that may correspond to one or more of the devices depicted in the previous figures. As illustrated, according to an exemplary embodiment, device 400 includes a processor 405, memory/storage 410, software 415, a communication interface 420, an input 425, and an output 430. According to other embodiments, device 400 may include fewer components, additional components, different components, and/or a different arrangement of components than those illustrated in FIG. 4 and described herein. For example, mobile device 150 may include a GPS receiver, an accelerometer, etc.

Processor 405 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (e.g., one or multiple cores), microcontrollers, and/or some other type of component that interprets and/or executes instructions and/or data. Processor 405 may be implemented as hardware (e.g., a microprocessor, etc.), a combination of hardware and software (e.g., a SoC, an ASIC, etc.), may include one or multiple memories (e.g., memory/storage 410), etc.

Processor 405 may control the overall operation or a portion of operation(s) performed by device 400. Processor 405 may perform one or multiple operations based on an operating system and/or various applications or programs (e.g., software 415). Processor 405 may access instructions from memory/storage 410, from other components of device 400, and/or from a source external to device 400 (e.g., a network, another device, etc.).

Memory/storage 410 includes one or multiple memories and/or one or multiple other types of storage mediums. For example, memory/storage 410 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a phase-change memory (PCM), a dual in-line memory module (DIMM), a flash memory, and/or some other type of memory. Memory/storage 410 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 410 may include drives for reading from and writing to the storage medium.

Memory/storage 410 may be external to and/or removable from device 400, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray® disk (BD), etc.). Memory/storage 410 may store data, software, and/or instructions related to the operation of device 400.

Software 415 includes an application or a program that provides a function and/or a process. Software 415 may include firmware. For example, network devices 110 may be implemented with one or more program(s) and/or application(s). Additionally, for example, with reference to user device 150, one or more program(s) and/or application(s) may be used to display user interfaces and communicate with network 105.

Communication interface 420 permits device 400 to communicate with other devices, networks, systems, etc. Communication interface 420 may include one or multiple wireless interfaces and/or wired interfaces. Communication interface 420 may include one or multiple transmitters, receivers, and/or transceivers. Communication interface 420 may operate according to one or multiple protocols, standards, and/or the like.

Input 425 permits an input into device 400. For example, input 425 may include a keyboard, a mouse, a display, a touchscreen, a touchless screen, a button, a switch, an input port, speech recognition logic, and/or some other type of visual, auditory, tactile, etc., input component. Output 430 permits an output from device 400. For example, output 430 may include a speaker, a display, a touchscreen, a touchless screen, a light, an output port, and/or some other type of visual, auditory, tactile, etc., output component.

Device 400 may perform processes and/or functions, as described herein, in response to processor 405 executing software 415 stored by memory/storage 410. By way of example, instructions may be read into memory/storage 410 from another memory/storage 410 or from another device via communication interface 420. The instructions stored by memory/storage 410 may cause processor 405 to perform one or more processes described herein. Alternatively, for example, according to other implementations, device 400 may perform one or more processes described herein based on the execution of hardware (processor 405, etc.).

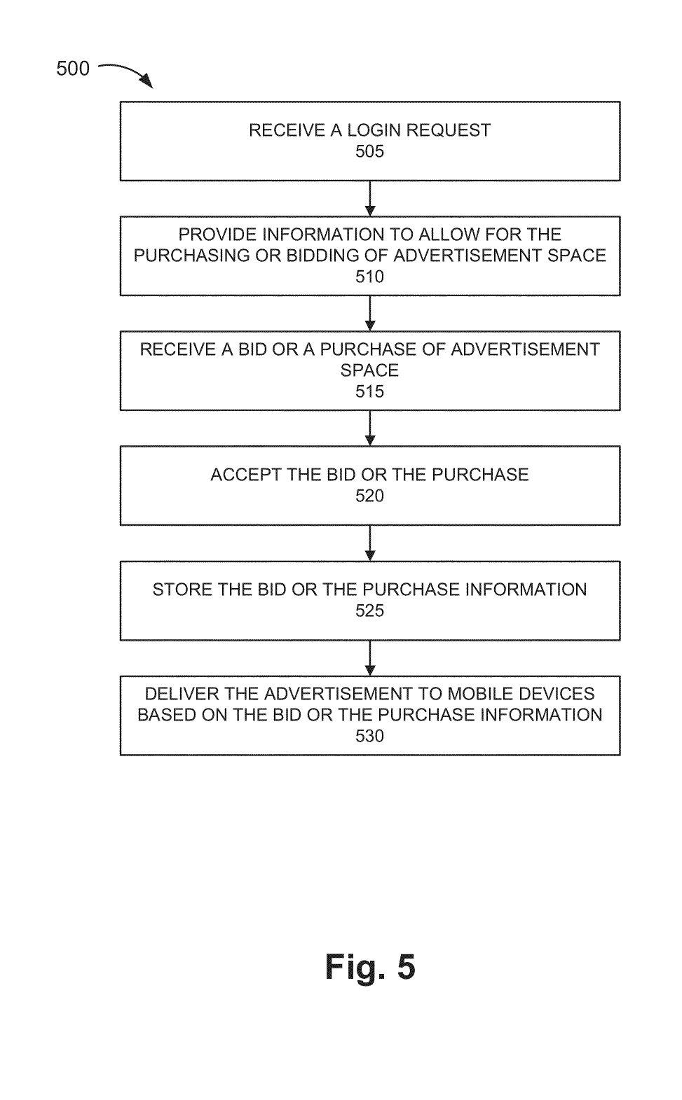

FIG. 5 is a flow diagram illustrating an exemplary process pertaining to an exemplary embodiment of the advertisement platform. For example, process 500 pertains to providing advertisement services. A step or an act described in process 500 is performed by one of the devices illustrated in FIG. 1A. For example, processor 405 of network device 110 may execute software 415 to perform the step or the act described. It may be assumed that a connection between network 105 and user device 175 exists.

Process 500 begins with receiving a login request (block 505). For example, a user of user device 175 enters login information with log-in device 110-1 of the advertisement information. Log-in device 110-1 validates the log-in information by comparing the log-in information to subscription information. According to this example, assume that the login request is validated.

In block 510, information to allow for the purchasing or bidding of advertisement space is provided. For example, advertisement selection device 110-2 provides information to the user to allow the user to purchase or bid on advertisement space pertaining to mobile devices 150. For example, as previously described, the information includes usage behavior pertaining to the users of mobile devices 150, device characteristics of mobile devices 150, network characteristics, subscription information, demographic information, statistical information, and available advertisement space. According to an exemplary embodiment, advertisement selection device 110-2 provides pricing information pertaining to the available advertisement space being offered. Advertisement selection device 110-2 provides user interfaces that allow for the selection of and purchase of advertisement space by time, day, geography, etc. According to another exemplary embodiment, advertisement selection device 110-2 provides user interfaces that allow for the selection of and bidding for advertisement space.

In block 515, a bid or a purchase of advertisement space is received. For example, advertisement selection device 110-2 receives a bid request (e.g., when auctioning) or a purchase request for advertisement space. The bid request or the purchase request may indicate a time period, the advertisement, a geographical area (e.g., a city, nationwide, etc.), the amount of advertisement space, a demographic, or other criterion based on the information provided in block 510.

According to an exemplary embodiment, advertisement selection device 110-2 may use user setting information (e.g., stored in advertisement space device 110-3) pertaining to mobile devices 150 that are to be included in the bid or the purchase. Advertisement selection device 110-2 may determine whether any mobile devices 150 are prohibited from receiving the advertisement due to one or more criteria set forth in the bid request or the purchase request and user settings pertaining to mobile devices 150. If there is a conflict, advertisement selection device 110-2 notifies the user making the bid or the purchase. The user may request that advertisement selection device 110-2 modify the bid request or the purchase request to accommodate the conflict. Alternatively, the user may re-formulate the bid request or the purchase request.

In block 520, the bid or the purchase is accepted. For example, advertisement selection device 110-2 accepts the bid or the purchase of advertisement space. Billing and discount device 110-4 generates an invoice and provides the invoice to the user via user device 175.

In block 525, the bid or the purchase information is stored. For example, billing and discount device 110-4 or some other device (e.g., advertisement selection device 110-2, etc.) stores the bid or the purchase information.

In block 530, the advertisement is delivered to mobile devices based on the bid or the purchase information. For example, advertisement storage device 110-5 uses the bid or the purchase information to provide the advertisement to mobile devices 150 in accordance with the bid or the purchase information. For example, the advertisement may be stored by advertisement storage device 110-5. Alternatively, the advertisement may be stored by another party. According to an exemplary implementation, advertisement storage device 110-5 may use user setting information (e.g., user settings pertaining to user of mobile device 150) when delivering the advertisement to mobile devices 150. For example, user setting information may change from the time of the purchase or the bid to the time of the delivery. Advertisement storage device 110-5 may account for any conflicts and provide this information to billing and discount device 110-4. Billing and discount device 110-4 may notify the user of user device 175. Mobile devices 150 receive the advertisement and are provided to users of mobile devices 150.

Although FIG. 5 illustrates an exemplary process 500 for providing an advertisement service, according to other implementations, process 500 may include additional operations, fewer operations, and/or different operations than those illustrated in FIG. 5 and described herein.

The foregoing description of embodiments provides illustration, but is not intended to be exhaustive or to limit the embodiments to the precise form disclosed. Accordingly, modifications to the embodiments described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks have been described with regard to the process illustrated in FIG. 5, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software and hardware. For example, a process or a function may be implemented as “logic” or as a “component.” This logic or this component may include hardware (e.g., processor 405, etc.) or a combination of hardware and software (e.g., software 415). The embodiments have been described without reference to the specific software code since software can be designed to implement the embodiments based on the description herein.

Additionally, embodiments described herein may be implemented as a non-transitory storage medium that stores data and/or information, such as instructions, program code, data structures, program modules, an application, etc. For example, a non-transitory storage medium includes one or more of the storage mediums described in relation to memory/storage 410. The data and/or information may be executed to perform processes or provide functions, as described herein.

In the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, or instruction described in the present application should be construed as critical or essential to the embodiments described herein unless explicitly described as such.

What is claimed is:

1. A method comprising:
receiving, by a network device, log-in information to access an advertisement service;
providing, by the network device, information to allow for a purchase of or a bid for advertisement space pertaining to mobile devices;
receiving, by the network device, a bid request or a purchase request for advertisement space;
accepting, by the network device, the bid request or the purchase request; and
delivering, by the network device, one or more advertisements to the mobile devices based on the accepted bid request or the accepted purchase request.

2. The method of claim 1, further comprising:
determining whether the bid request or the purchase request conflicts with user settings pertaining to receiving advertisements by the mobile devices; and
indicating that the bid request or the purchase request conflicts with the user settings in response to determining that a conflict exists.

3. The method of claim 1, further comprising:
performing real-time tracking of available advertisement space for each of the mobile devices, and wherein the providing includes providing the information that includes the available advertisement space for the mobile devices.

4. The method of claim 3, wherein the available advertisement space includes information indicating an amount of display area available on each mobile device.

5. The method of claim 3, further comprising:
calculating a credit, corresponding to the available advertisement space, for each mobile device; and
applying the credit to a service used by users of the mobile devices, wherein the service includes at least one of a mobile service, an Internet service, a television service, or a home monitoring service.

6. The method of claim 1, further comprising:
receiving usage behavior information pertaining to users of the mobile devices, and wherein the providing includes providing the information that includes the usage behavior information.

7. The method of claim 1, further comprising:
storing advertisements;
receiving an advertisement on-demand request for an advertisement;
searching the stored advertisements based on the advertisement on-demand request;
selecting an advertisement based on the searching; and
delivering the advertisement to a mobile device in response to the selecting.

8. The method of claim 1, further comprising:
identifying the number of mobile devices turned on or connected to a service during a particular period; and
setting a price for the advertisement space based on the identifying.

9. A system comprising:
one or more network devices, wherein each network device comprises
a communication interface;
a memory that stores instructions; and
a processor to execute the instructions, wherein at least one of the processors of the one or more network devices execute the instructions to:
receive, via one of the communication interfaces, log-in information to access an advertisement service;
provide information to allow for a purchase of or a bid for advertisement space pertaining to mobile devices;
receive, via one of the communication interfaces, a bid request or a purchase request for advertisement space;
accept the bid request or the purchase request; and
deliver, via one of the communication interfaces, one or more advertisements to the mobile devices based on the accepted bid request or the accepted purchase request.

10. The system of claim 9, wherein at least one of the one or more processors of the one or more network devices execute the instructions to:
determine whether the bid request or the purchase request conflicts with user settings pertaining to receiving advertisements by the mobile devices; and
indicate, via a user interface, that the bid request or the purchase request conflicts with the user settings in response to a determination that a conflict exists.

11. The system of claim 9, wherein at least one of the one or more processors of the one or more network devices execute the instructions to:
perform real-time tracking of available advertisement space for each of the mobile devices, and wherein the information includes the available advertisement space for the mobile devices.

12. The system of claim 9, wherein at least one of the one or more processors of the one or more network devices execute the instructions to:
receive usage behavior information pertaining to users of the mobile devices, and wherein the providing includes providing the information that includes the usage behavior information.

13. The system of claim 9, wherein at least one of the one or more processors of the one or more network devices execute the instructions to:
calculate a credit, corresponding to the available advertisement space, for each mobile device; and
apply the credit to a service used by users of the mobile devices, wherein the service includes at least one of a mobile service, an Internet service, a television service, or a home monitoring service.

14. The system of claim 9, wherein at least one of the one or more processors of the one or more network devices execute the instructions to:
store advertisements; and wherein to deliver includes to cause the one or more advertisements to be displayed on at least one screen of the mobile devices.

15. The system of claim 9, wherein at least one of the one or more processors of the one or more network devices execute the instructions to:
track user responses to the one or more advertisements delivered to the mobile devices.

16. The system of claim 9, wherein at least one of the one or more processors of the one or more network devices execute the instructions to:
store user settings pertaining to receiving advertisements by users of the mobile devices; and wherein to deliver includes using the user settings to identify whether a conflict exists when the advertisement service pertaining to the bid request or the purchase request is to be provided.

17. A non-transitory storage medium storing instructions executable by a computational device, wherein the instructions comprise instructions to:
receive log-in information to access an advertisement service;
provide information to allow for a purchase of a bid of advertisement space pertaining to mobile devices;
receive a bid request or a purchase request for advertisement space;
accept the bid request or the purchase request; and
deliver one or more advertisements to the mobile devices based on the accepted bid request or the accepted purchase request.

18. The non-transitory storage medium of claim 17, wherein the instructions comprise further instructions to:
perform real-time tracking of available advertisement space for each of the mobile devices, and wherein the providing includes providing the information that includes the available advertisement space for the mobile devices.

19. The non-transitory storage medium of claim 18, wherein the instructions comprise further instructions to:
calculate a credit, corresponding to the available advertisement space, for each mobile device; and
apply the credit to a service used by the users of the mobile devices, wherein the service includes at least one of a mobile service, an Internet service, a television service, or a home monitoring service.

20. The non-transitory storage medium of claim 17, wherein the instructions comprise further instructions to:
calculate a price for the advertisement space is to be sold.
